(19) United States
(12) Patent Application Publication
(10) Pub. No.: US 2018/0330150 A1
(43) Pub. Date: Nov. 15, 2018

(54) FACE IDENTIFICATION MODULE

(71) Applicant: ASIA VITAL COMPONENTS CO., LTD., New Taipei City (TW)

(72) Inventors: Wei-Chuan Wang, New Taipei City (TW); Xin-Lian Cheng, New Taipei City (TW); Ting-Yu Lin, New Taipei City (TW); Chih-Liang Yeh, New Taipei City (TW)

(21) Appl. No.: 15/593,344

(22) Filed: May 12, 2017

(51) Int. Cl. G06K 9/00; H04N 5/33; H04N 5/225

(52) U.S. Cl. CPC G06K 9/00255; H04N 5/2258; H04N 5/2256; H04N 5/33

(57) ABSTRACT

A face identification module includes a substrate. The substrate has a first plane face. On the first place face are disposed a first lens assembly, a second lens assembly, an infrared LED assembly and an image processor, which are respectively electrically connected with the substrate. The infrared LED assembly includes a first infrared LED and a second infrared LED. The first infrared LED and the second infrared LED are adjacently disposed on left and right sides of the second lens assembly. In the face identification module, the video function and the face identification function are integrated to save arrangement space and achieve a multiplex face identification module.

### BACKGROUND OF THE INVENTION

### 1. Field of the Invention

The present invention relates generally to a face identification module, and more particularly to a face identification module, in which the face identification function and the video function are integrated.

### 2. Description of the Related Art

A conventional camera device is mainly used to take photos or shoot a film and perform internet video. The conventional camera device fails to fully satisfy the higher and higher human-machine interaction requirement of peoples. A user needs a simpler, more convenient and quicker human-machine interaction experience. Therefore, a human-machine interaction interface has been developed by those who are skilled in this field. Due to the limitation of hardware and imaging technique and the high cost for the camera device, the current face identification mechanism can be hardly widely applied to the display device. Therefore, the camera device cannot popularly interactively perform the face feature identification work.

The conventional face identification technique is mainly based on the visible light image. Such manner has some shortcomings that can be hardly overcome. When the environmental light changes, the identification effect will abruptly deteriorate. This cannot satisfy the requirement of the real system. For example, when taking a picture, in case a black-and-white face phenomenon takes place due to side light, it may be impossible to correctly identify the face.

Moreover, in the condition that the light is refracted and reflected to cause insufficient light source, the colored camera lens is apt to cause shadow on the five sense organs of the face and lead to the problem of unobvious face features. As a result, it often takes place that the face features cannot be identified or mis-identified.

Furthermore, in case a black-and-white camera lens is used instead of the colored camera lens, when it is necessary to perform internet video, no color is presented. This is quite inconvenient.

It is therefore tried by the applicant to provide a face identification module to improve the face identification precision and also provide video function.

### SUMMARY OF THE INVENTION

It is therefore a primary object of the present invention to provide a face identification module, in which the face identification function and the video function are integrated.

To achieve the above and other objects, the face identification module of the present invention includes a substrate. The substrate has a first plane face. On the first place face are disposed a first lens assembly, a second lens assembly, an infrared LED assembly and an image processor, which are respectively electrically connected with the substrate. The infrared LED assembly includes a first infrared LED and a second infrared LED. The first infrared LED and the second infrared LED are adjacently disposed on left and right sides of the second lens assembly.

In the above face identification module, the first lens assembly is a conventional RGB camera lens, while the second lens assembly is an infrared camera lens in cooperation with the infrared LED assembly.

The first lens assembly (RGB camera lens) serves to capture 2D picture information so as to ensure the quality of the RGB image and satisfy the video and photographing functions of a user. The second lens assembly (infrared camera lens) and the infrared LED assembly cooperate with each other, whereby the infrared image performance is better with respect to the face identification. This is more beneficial to the face identification. The power of the infrared LED assembly is varied in a dynamic detection manner. That is, the closer the shot object is, the lower the power is, while the farther the shot object is, the higher the power is. The cost for the heat dissipation structure of the structural design of the present invention is relatively low. The present invention can enhance the face identification precision and also provide colored video image transmission.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective exploded view of a first embodiment of the face identification module of the present invention;

FIG. 2 is a perspective assembled view of the first embodiment of the face identification module of the present invention;

FIG. 3 is a perspective assembled view of a second embodiment of the face identification module of the present invention; and

FIG. 4 is a perspective assembled view of a third embodiment of the face identification module of the present invention.

### DETAILED DESCRIPTION OF THE PREFERRED EMBODIMENTS

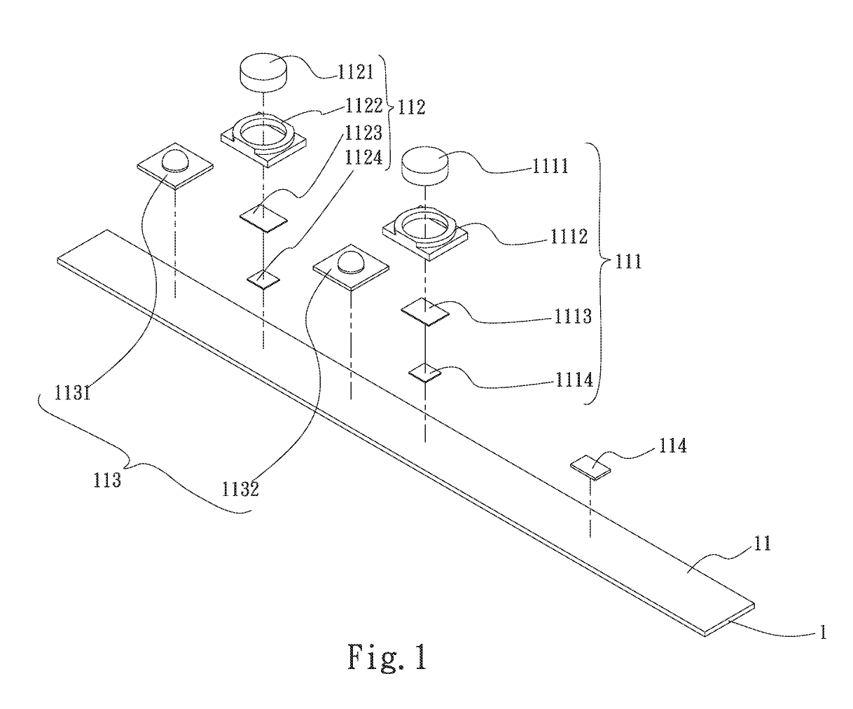

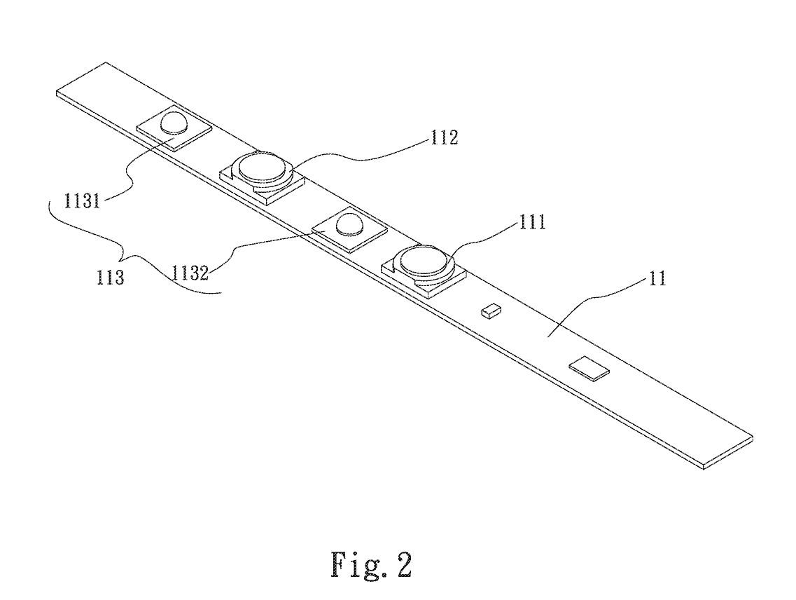

Please refer to FIGS. 1 and 2. FIG. 1 is a perspective exploded view of a first embodiment of the face identification module of the present invention. FIG. 2 is a perspective assembled view of the first embodiment of the face identification module of the present invention. According to the first embodiment, the face identification module of the present invention includes a substrate 1.

The substrate 1 has a first plane face 11. On the first place face 11 are disposed a first lens assembly 111, a second lens assembly 112, an infrared LED assembly 113 and an image processor 114, which are respectively electrically connected with the substrate 1. The infrared LED assembly 113 includes a first infrared LED 1131 and a second infrared LED 1132. The first infrared LED 1131 and the second infrared LED 1132 are adjacently disposed on left and right sides of the second lens assembly 112.

The first lens assembly 111 has a first lens 1111, a first lens base seat 1112, a first filter 1113 and a first image sensation unit 1114. The components of the first lens assembly 111 are sequentially stacked and assembled with each other.

The second lens assembly 112 has a second lens 1121, a second lens base seat 1122, a second filter 1123 and a second image sensation unit 1124. The components of the second lens assembly 112 are sequentially stacked and assembled with each other.

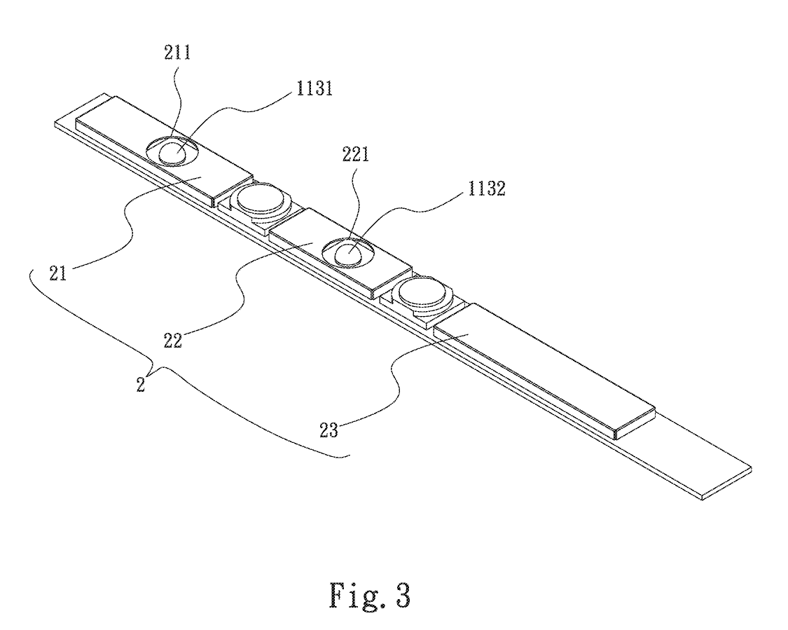

Please now refer to FIG. 3, which is a perspective assembled view of a second embodiment of the face identification module of the present invention. The second embodiment is partially identical to the first embodiment in structure and thus will not be repeatedly described hereinafter. The second embodiment is different from the first embodiment in that the second embodiment further includes a case assembly 2. The case assembly 2 has a first case 21, a second case 22 and a third case 23 correspondingly arranged on the first plane face 11 at intervals to cover and protect the first infrared LED 1131, the second infrared LED 1132 and the image processor 114. The first and second cases 21, 22 are respectively formed with perforations 211, 221 in the position where the first infrared LED 1131 and the second infrared LED 1132 are positioned. Accordingly, the first infrared LED 1131 and the second infrared LED 1132 are respectively partially exposed to outer sides of the first and second cases 21, 22 through the perforations 211, 221.

The first, second and third cases 21, 22, 23 mainly serve to protect the first and second lens assemblies 111, 112 and the first and second infrared LED 1131, 1132 and the image processor 114 (as shown in FIG. 1).

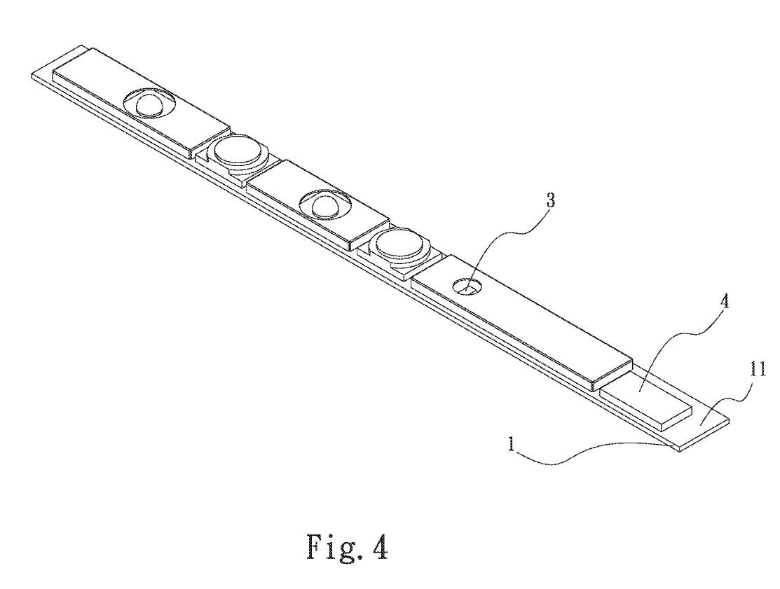

Please now refer to FIG. 4, which is a perspective assembled view of a third embodiment of the face identification module of the present invention. The third embodiment is partially identical to the first embodiment in structure and thus will not be repeatedly described hereinafter. The third embodiment is different from the first embodiment in that the third embodiment further includes an LED indicator lamp 3 and a connector 4 disposed on the first plane face 11 of the substrate 1 and electrically connected with the substrate 1.

In the present invention, the first lens assembly 111 is a conventional RGB camera lens, while the second lens assembly 112 is an infrared camera lens in cooperation with the infrared LED assembly 113.

The first lens assembly 111 (RGB camera lens) serves to capture 2D picture information so as to ensure the quality of the RGB image and satisfy the video and photographing functions of a user. The second lens assembly 112 (infrared camera lens) and the infrared LED assembly 113 cooperate with each other, whereby the infrared image performance is better with respect to the face identification. This is more beneficial to the face identification. The power of the infrared LED assembly 113 is varied in a dynamic detection manner. That is, the closer the shot object is, the lower the power is, while the farther the shot object is, the higher the power is. The cost for the heat dissipation structure of the structural design of the present invention is relatively low. The present invention can enhance the face identification precision and also provide colored video image transmission.

The present invention has been described with the above embodiments thereof and it is understood that many changes and modifications in such as the form or layout pattern or practicing step of the above embodiments can be carried out without departing from the scope and the spirit of the invention that is intended to be limited only by the appended claims.

What is claimed is:

1. A face identification module comprising a substrate, the substrate having a first plane face, on the first place face being disposed a first lens assembly, a second lens assembly, an infrared LED assembly and an image processor, which are respectively electrically connected with the substrate, the infrared LED assembly including a first infrared LED and a second infrared LED, the first infrared LED and the second infrared LED being adjacently disposed on left and right sides of the second lens assembly.

2. The face identification module as claimed in claim 1, further comprising a connector disposed on the first plane face of the substrate and electrically connected with the substrate.

3. The face identification module as claimed in claim 1, further comprising an LED indicator lamp disposed on the first plane face of the substrate and electrically connected with the substrate.

4. The face identification module as claimed in claim 1, further comprising a case assembly, the case assembly having a first case, a second case and a third case correspondingly arranged on the first plane face at intervals to cover and protect the first infrared LED, the second infrared LED and the image processor, the first and second cases being respectively formed with perforations in the position where the first infrared LED and the second infrared LED are positioned, whereby the first infrared LED and the second infrared LED are respectively partially exposed to outer sides of the first and second cases through the perforations.

5. The face identification module as claimed in claim 1, wherein the first lens assembly has a first lens, a first lens base seat, a first filter and a first image sensation unit.

6. The face identification module as claimed in claim 1, wherein the second lens assembly has a second lens, a second lens base seat, a second filter and a second image sensation unit.
